(19) United States
(12) Patent Application Publication
(10) Pub. No.: US 2022/0407124 A1
(43) Pub. Date: Dec. 22, 2022

(54) CELL AND METHOD FOR PRODUCTION THEREOF

(71) Applicant: VARTA Microbattery GmbH, Ellwangen Jagst (DE)

(72) Inventors: Martin Elmer, Ellwangen (DE); Philipp Renschler, Ellwangen (DE)

(21) Appl. No.: 17/828,099

(22) Filed: May 31, 2022

(30) Foreign Application Priority Data
Jun. 17, 2021 (EP) 21180182.4

(51) Int. Cl. H01M 10/42; H01M 10/04; G06K 19/07; G06K 19/077

(52) U.S. Cl. CPC H01M 10/4257; H01M 10/0427; G06K 19/0723; G06K 19/0702; G06K 19/07773; H01M 2010/4278

(57) ABSTRACT

An electrochemical cell capable of energy storage, includes: a housing that encloses an interior space, a composite body arranged in the interior space and formed from at least two electrodes and at least one separator, and an RFID transponder, the memory of which contains data about the cell.

### TECHNICAL FIELD

This disclosure relates to an electrochemical cell capable of energy storage and a method of producing such an electrochemical cell.

### BACKGROUND

Electrochemical cells capable of energy storage are capable of converting stored chemical energy into electrical energy by a redox reaction. They generally comprise a positive and a negative electrode separated from one another by a separator. During discharge, electrons are released at the negative electrode by an oxidation process. This results in an electron current that can be tapped off by an external electrical load for which the electrochemical cell serves as energy supplier. At the same time, an ion current corresponding to the electrode reaction occurs within the cell. The ion current crosses the separator and is made possible by an ion-conducting electrolyte.

If the discharge is reversible, i.e. there is the possibility of reversing the conversion of chemical energy into electrical energy that took place during discharge and of thus charging the cell, the cell is called a secondary cell. The designation of the negative electrode as anode and the positive electrode as cathode, as is generally customary for secondary cells, is based on the discharge function of the electrochemical cell.

The widespread secondary lithium ion cells are based on the use of lithium, which can migrate back and forth between the electrodes of the cell in the form of ions. Lithium ion cells are distinguished by high energy density.

The negative and the positive electrode of a lithium ion cell are generally so-called composite electrodes comprising not only electrochemically active components (in particular, components that can reversibly intercalate and deintercalate lithium ions), but also electrochemically inactive components (conductive materials, electrode binders, current collectors). During production of a lithium ion cell, the composite electrodes are combined with one or more separators to form a composite body. The electrodes and separators are joined together with or without application of pressure.

In many instances, the composite body is simply designed such that multiple composite bodies can be stacked. Such composite bodies are generally formed by using rectangular electrodes and separators. However, it is very common for the composite body to be formed in the form of a winding or to be processed to form a winding. This requires tape-shaped electrodes and separators. Irrespective of whether it is wound or not, the composite body generally comprises the sequence positive electrode/separator/negative electrode. Composite bodies in the form of so-called bicells are commonly produced with the possible sequences negative electrode/separator/positive electrode/separator/negative electrode or positive electrode/separator/negative electrode/separator/positive electrode.

Composite electrodes are usually produced by applying a flat layer of a pasty electrode material containing not only an electrode binder and possibly a conductive material, but also an electrochemically active component (often also referred to as active material) in particle form, to a suitable current collector and then drying it. The electrode material is preferably applied to both sides of the current collector. With respect to production, this is usually realized by providing the current collector as virtually continuous tapes, which then pass through a coating device which, through intermittent coating, provides the current collector with a deposited coating interrupted at defined intervals in the running direction. Accordingly, the current collector tape exiting from the coating device comprises preferably alternatingly coated and uncoated segments in the running direction.

The current collector tape can then be separated by cutting the tape in the uncoated segments. If needed, the current collector tape can additionally be cut into strips. Two or more individual electrodes can thus be produced from each of the coated segments.

After the electrodes thus produced have been processed to form composite bodies, for example by winding in a winding machine, they are transferred into a housing. The basic functionality of the cell can then be established by impregnating the composite body with an electrolyte. The cell thus formed can then be subjected to a function and performance test.

What is of central importance for the quality of a cell is the freedom from defects of the electrodes produced. The use of defective electrodes generally means that cells built therewith must be sorted out as rejects. In production of composite bodies, defects impairing the functionality of the cells can occur, too.

It would be desirable to be able to detect as early as possible any defects and tolerance deviations that may occur at least for the most relevant components of an electrochemical cell and to ideally sort out as quickly as possible components that are defective or outside of a tolerance. This would require traceability of the components in the production chain and naturally a corresponding possibility of unambiguous identification. Currently, individual components of electrochemical cells can at best be assigned to batches. It would, in particular, also be helpful to be able to assign individual components of a cell to production machines on which they were produced.

### SUMMARY

We provide an electrochemical cell capable of energy storage, including: a housing that encloses an interior space, a composite body arranged in the interior space and formed from at least two electrodes and at least one separator, and an RFID transponder, the memory of which contains data about the cell.

We also provide a method of producing an electrochemical cell capable of energy storage, including forming a housing that encloses an interior space, arranging a composite body in the interior space and formed from at least two electrodes and at least one separator, equipping the cell with an RFID transponder, the memory of which contains information about the cell.

### BRIEF DESCRIPTION OF THE DRAWINGS

Further advantages and aspects will be apparent from the appended claims and the following description of preferred examples elucidated below on the basis of the figures.

FIG. 1 schematically shows one example of a composite body for a cell (top view, obliquely from the front).

FIG. 2 schematically shows an RFID transponder particularly suitable for use in a cell (top view, obliquely from the front).

FIG. 3 schematically shows a further possible example of a composite body for a cell (top view, obliquely from the front).

FIG. 4 schematically shows one example of a cell (cross-sectional view).

FIG. 5 schematically shows a further example of a cell (cross-sectional view).

FIG. 6 schematically shows a further example of a cell (cross-sectional view).

### DETAILED DESCRIPTION

Our electrochemical cells are capable of energy storage and comprise a composite body formed from at least two electrodes and at least one separator. Our cells therefore comprise:
a housing that encloses an interior space and is preferably composed of two or more housing parts, and
a composite body is arranged in the interior space and formed from the at least two electrodes and the at least one separator.

The cell is equipped with an RFID transponder, the memory of which contains data about the cell. Besides the memory, the RFID transponder preferably comprises an antenna and an analogue circuit for receiving and transmitting data (transceiver). Furthermore, the RFID transponder preferably comprises a digital circuit that can optionally be a small microcontroller.

The memory can be a permanent memory, i.e. a non-changeable memory. In some examples, the memory can, however, also be a rewritable memory in which data can be changed and/or information added.

Preferably, the RFID transponder is a passive transponder that can receive high-frequency energy via its antenna and convert it into electrical energy that powers the remaining components of the transponder. In some examples, the transponder can, however, also be an active RFID transponder, the components of which are supplied with electrical energy from an electrochemical cell. In one example, the transponder can be electrically connected to the electrodes of the composite body to this end.

Our cells are preferably secondary lithium ion cells comprising the composite electrodes composed of current collectors coated with electrode materials mentioned above. In the composite body, the electrodes are arranged in the sequence positive electrode/separator/negative electrode.

The active materials for anode and cathode of the cells can be basically all electrochemically active components known for secondary lithium ion cells.

In the negative electrode, the active materials can be carbon-based particles such as graphitic carbon or non-graphitic carbon materials capable of intercalating lithium, preferably also in particle form. Furthermore, metallic and semi-metallic materials alloyable with lithium can also be used. For example, the elements tin, aluminium, antimony and silicon are capable of forming intermetallic phases with lithium. Some compounds of silicon, aluminium, tin and/or antimony can also reversibly incorporate and release lithium. For example, in some preferred examples, silicon in oxidic form can be contained in the negative electrode. Alternatively or additionally, lithium titanate (Li₄Ti₅O₁₂) or a derivative thereof can also be contained in the negative electrode, preferably also in particle form.

For the positive electrode, possible active materials are, for example, lithium metal oxide compounds and lithium metal phosphate compounds such as LiCoO₂ and LiFePO₄. Additionally highly suited are, in particular, lithium nickel manganese cobalt oxide (NMC) having the molecular formula LiNiₓMn_{y}Co_{z}O₂ (wherein x+y+z is typically 1), lithium manganese spinel (LMO) having the molecular formula LiMn₂O₄, or lithium nickel cobalt aluminium oxide (NCA) having the molecular formula LiNiₓCo_{y}Al_{z}O₂ (wherein x+y+z is typically 1). Derivatives thereof, for example, lithium nickel manganese cobalt aluminium oxide (NMCA) having the molecular formula Li_{1.11}(Ni_{0.40}Mn_{0.39}Co_{0.16}Al_{0.05})_{0.89}O₂ or Li₁₊ₓM—O compounds and/or mixtures of the stated materials, can be used, too.

The active materials are preferably embedded in a matrix composed of an electrode binder, adjacent particles in the matrix preferably being in direct contact with one another. Customary electrode binders are, for example, based on polyvinylidene fluoride (PVDF), polyacrylate or carboxymethylcellulose.

Furthermore, conductive materials can be added to the electrodes. Conductive materials increase the electrical conductivity of the electrodes. Customary conductive materials are carbon black and metal powder.

In the finished cell, the composite body is preferably impregnated with an electrolyte, preferably an electrolyte based on at least one lithium salt such as, for example, lithium hexafluorophosphate (LiPF₆) dissolved in an organic solvent (e.g. in a mixture of organic carbonates or a cyclic ether such as THF or a nitrile). Other usable lithium salts are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

The current collectors electrically contact over as large an area as possible electrochemically active components contained in the electrode material. Preferably, the current collectors consist of a metal or are at least surface-metallized. Suitable metals for the anode current collector are, for example, copper or nickel or else other electrically conductive materials, in particular copper and nickel alloys or nickel-coated metals. Stainless steel is in principle a possibility, too. Suitable metals for the cathode current collector are, for example, aluminium or else other electrically conductive materials, in particular aluminium alloys as well.

Preferably, metal foils, for example, having a thickness of 4 μm to 30 μm, are respectively used as the anode current collector and/or as the cathode current collector. Besides foils, the current collectors used can, however, also be other substrates such as metallic or metallized nonwovens or open-pore foams or expanded metals.

The separator used can, for example, be an electrically insulating plastic film. It preferably comprises micropores so that it can be penetrated by the electrolyte. The film can, for example, be formed from a polyolefin or from a polyetherketone. It is not excluded that nonwovens and wovens composed of such plastic materials or similar plastic materials can also be used as separators.

The cells, in particular the lithium ion cells, can be a button cell. Button cells are cylindrical and have a height which is smaller than its diameter. Preferably, the height of the button cell to be produced is 4 mm to 15 mm. Furthermore, it is preferred that the button cell has a diameter of 5 mm to 25 mm. Button cells are, for example, suitable for supplying small electronic devices such as watches, hearing aids and wireless headphones with electrical energy.

The nominal capacity of a lithium ion cell in the form of a button cell is generally up to 1500 mAh. The nominal capacity preferably is 100 mAh to 1000 mAh and particularly preferably 100 to 800 mAh.

Particularly preferably, the cell, in particular the lithium ion cell, is a cylindrical round cell. Cylindrical round cells have a height which is larger than its diameter. They are especially suitable for applications in the automobile sector, for e-bikes or else for other applications with a high energy demand.

The height of cylindrical round cells preferably is 15 mm to 150 mm. The diameter of the cylindrical round cells preferably is 10 mm to 60 mm. Within these ranges, preference may be given to, for example, form factors of, for example, 18×65 (diameter×height in mm) or 21×70 (diameter×height in mm). Cylindrical round cells having these form factors are especially suitable for supplying power to electrical drives of motor vehicles.

The nominal capacity of a lithium ion-based cylindrical round cell is preferably up to 90 000 mAh. With the form factor of 21×70, the cell embodied as a lithium ion cell has a nominal capacity preferably of 1500 mAh to 7000 mAh, particularly preferably 3000 to 5500 mAh. With the form factor of 18×65, the cell embodied as a lithium ion cell has a nominal capacity preferably of 1000 mAh to 5000 mAh, particularly preferably 2000 to 4000 mAh.

In the European Union, manufacturer specifications in relation to data concerning the nominal capacities of secondary batteries are strictly regulated. For instance, data about the nominal capacity of secondary nickel-cadmium batteries must be based on measurements in accordance with the standards IEC/EN 61951-1 and IEC/EN 60622, data about the nominal capacity of secondary nickel-metal hydride batteries must be based on measurements in accordance with the standard IEC/EN 61951-2, data about the nominal capacity of secondary lithium batteries must be based on measurements in accordance with the standard IEC/EN 61960, and data about the nominal capacity of secondary lead-acid batteries must be based on measurements in accordance with the standard IEC/EN 61056-1. Any data about nominal capacities herein are preferably likewise based on these standards.

Our cells are preferably distinguished by at least one of the additional features a. to c.:
a. the data allow unambiguous identification of the cell,
b. the data allow assignment of the cell to a machine which was used in the production of the cell, and
c. the data comprise information about components of the cell, in particular about the composite body and/or the at least two electrodes.

Preferably, features a. to c. immediately above are realized in combination.

There are four particularly preferred examples, according to which the cell can be equipped with the RFID transponder.

According to example 1, the cell is distinguished by at least one of the additional features a. to d.:
a. the composite body is a cylindrical winding in which the at least two electrodes and the at least one separator are tape-shaped and spirally rolled-up,
b. the composite body comprises an axial cavity,
c. the RFID transponder is arranged in the axial cavity, and
d. the RFID transponder is in the form of a winding core or part of a winding core.

Preferably, features a. to c. immediately above are realized in combination. Particularly preferably, features a. to d. immediately above are realized in combination.

According to example 2, the cell is distinguished by at least one of the additional features a. to c. that immediately follow:
a. the composite body is a cylindrical winding in which the at least two electrodes and the at least one separator are tape-shaped and spirally rolled-up,
b. the RFID transponder is integrated in an adhesive strip or arranged on an adhesive strip, which adhesive strip is adhered to the winding on the lateral surface, and
c. the winding is held together by the adhesive strip.

Preferably, features a. and b. immediately above are realized in combination. Particularly preferably, features a. to c. immediately above are realized in combination.

According to example 3, the cell is distinguished by at least one of the additional features a. to c.:
a. the housing is a cylindrical metal housing comprising a circumferential lateral housing surface and, at the end faces, a circular bottom and a lid,
b. the bottom and/or the lateral housing surface are covered by an electrically insulating layer on their outer face, and
c. the RFID transponder is arranged between the bottom and the electrically insulating layer or between the lateral housing surface and the electrically insulating layer or is integrated in the electrically insulating layer.

Preferably, features a. to c. immediately above are realized in combination.

According to example 4, the cell is distinguished by at least one of the additional features a. to c.:
a. the housing is a cylindrical metal housing comprising a circumferential lateral housing surface and, at the end faces, a circular bottom and a lid,
b. the RFID transponder is integrated in an electrically insulating ring or is in the form of a ring, the ring being arranged on the lid, and
c. the ring is fixed on the lid by heat-shrink tubing applied to the lateral housing surface.

Preferably, features a. to c. immediately above are realized in combination.

Each of the examples is associated with particular advantages, which will be described in more detail in connection with the exemplary structures described below.

Our methods serve for production of an electrochemical cell capable of energy storage, comprising:
a housing that encloses an interior space, and
a composite body arranged in the interior space and which is formed from at least two electrodes and at least one separator.

The cell is equipped during production with an RFID transponder, the memory of which contains information about the cell.

The method of producing a cell as per the above-described example 1 preferably comprises features a. to c.:
a. the composite body is a cylindrical winding in which the at least two electrodes and the at least one separator are tape-shaped and spirally rolled-up,
b. the composite body comprises an axial cavity, and
c. the RFID transponder is arranged in the axial cavity.

Further preferably, the method of producing a cell as per the above-described example 1, comprises features a. and b.:
a. the RFID transponder is in the form of a winding core or part of a winding core, and
b. the at least two electrodes and the at least one separator are tape-shaped and are spirally rolled up on the winding core to form the composite body, resulting in a cylindrical winding.

The method of producing a cell as per the above-described example 2 preferably comprises features a. to c.:
a. the at least two electrodes and the at least one separator are tape-shaped and are spirally rolled up to form the composite body, resulting in a cylindrical winding,
b. the winding is held together by an adhesive strip which is adhered to the winding on the lateral surface, and
c. the RFID transponder is integrated in the adhesive strip or arranged on the adhesive strip.

The method of producing a cell as per the above-described example 3 preferably comprises features a. to c.:
a. the housing is a cylindrical metal housing comprising a circumferential lateral housing surface and, at the end faces, a circular bottom and a lid,
b. the bottom and/or the lateral housing surface are covered by an electrically insulating layer on their outer face, and
c. the RFID transponder is arranged between the bottom and the electrically insulating layer or between the lateral housing surface and the electrically insulating layer or it is integrated in the electrically insulating layer.

The method of producing a cell as per the above-described example 4 preferably comprises features a. to c.:
a. the housing is a cylindrical metal housing comprising a circumferential lateral housing surface and, at the end faces, a circular bottom and a lid,
b. the RFID transponder is integrated in an electrically insulating ring or is in the form of a ring, the ring being arranged on the lid, and
c. the ring is fixed on the lid by heat-shrink tubing applied to the lateral housing surface.

What is basically storable in the RFID tag of the cell is any information which can be read and, if necessary, also amended or supplemented in a contactless manner. Especially in examples in which the RFID tag is located inside the cell housing, the information is protected.

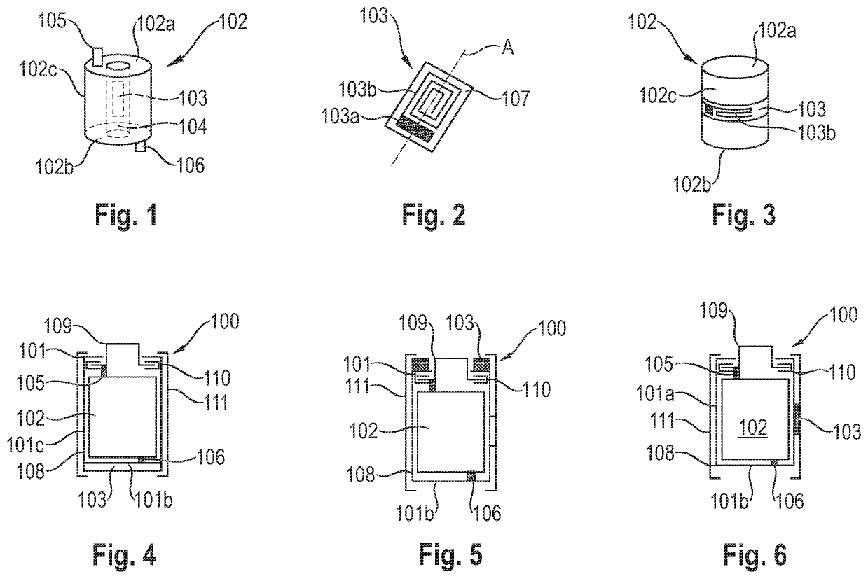

FIG. 1 shows a composite body 102 which is a cylindrical winding in which the at least two electrodes and the at least one separator are tape-shaped and spirally rolled-up. The composite body 102 has an upper end face 102a and a lower end face 102b and also an outer lateral composite-body surface 102c. Exiting from the upper end face 102a is a conductor 105 which, for example, is coupled to a positive electrode. Exiting from the lower end face 102b is a conductor 106 which, for example, is coupled to a negative electrode.

In its center, the composite body 102 comprises an axial cavity 104. Arranged therein is an RFID transponder 103 that, for example, can provide information about the electrodes of the composite body 102.

FIG. 2 shows a passive RFID transponder 103 arranged on a support 107. It comprises an antenna 103b and a circuit 103a which also comprises a data memory. The support 107 can, for example, be a foil. In particular examples, the foil can be an adhesive foil which has a layer of adhesive on the rear face. Transponders in such examples are obtainable with thicknesses of well below one millimeter. It is easily possible to wind them up spirally, for instance around the axis A. In wound-up form, such a transponder can, for example, be pushed into the axial cavity 104 of the composite body 102 depicted in FIG. 1. It is, however, also possible to use a wound-up transponder 103 as a winding core and, for example, to form the composite body 102 depicted in FIG. 1 by winding up electrodes and separators on the wound-up transponder 103.

FIG. 3 shows a further composite body 102 for a cell. It is likewise in the form of a cylindrical winding which was produced from tape-shaped electrodes and separators, and it has an upper end face 102a and a lower end face 102b and also an outer lateral composite-body surface 102c. Such a spirally rolled-up winding is generally stabilized by adhesive tape which is adhered to its outer lateral composite-body surface. In this example, an RFID transponder 103 is adhered to the outer lateral composite-body surface 102c instead of adhesive tape. Particularly suitable therefor are RFID transponders which comprise adhesive film or a label on which they are arranged.

FIG. 4 shows a cell 100. It comprises a cylindrical metal housing 101 comprising a circumferential lateral housing surface 101c and, at the lower end face, a circular bottom 101b. The housing 101 is formed from the housing cup 108 and the lid 109. The lid 109 has a circular edge onto which an electrically insulating gasket 110 has been pulled on. Arranged in the housing is the cylindrical composite body 102 consisting of spirally wound-up electrodes and separators. Exiting from the upper end face of the composite body 102 is a conductor 105 that electrically connects a positive electrode of the composite body 102 to the lid 109. Exiting from the lower end face of the composite body 102 is a conductor 106 that electrically connects a negative electrode of the composite body 102 to the housing cup 108. Large portions of the outer face of the housing 101 are electrically insulated. The lateral housing surface 101c is insulated by the heat-shrink tubing 111. The bottom 101b is shielded by the RFID transponder 103. Particularly suitable therefor as well are RFID transponders which comprise adhesive film or a label on which they are arranged.

FIG. 5 shows a cell 100. It comprises a cylindrical metal housing 101 comprising a circumferential lateral housing surface 101c and, at the lower end face, a circular bottom 101b. The housing 101 is formed from the housing cup 108 and the lid 109. The lid 109 has a circular edge onto which an electrically insulating gasket 110 has been pulled on. Arranged in the housing is the cylindrical composite body 102 consisting of spirally wound-up electrodes and separators. Exiting from the upper end face of the composite body 102 is a conductor 105 that electrically connects a positive electrode of the composite body 102 to the lid 109. Exiting from the lower end face of the composite body 102 is a conductor 106 that electrically connects a negative electrode of the composite body 102 to the housing cup 108. The lateral housing surface 101c is electrically insulated by the heat-shrink tubing 111. An RFID transponder 103 is in the form of a ring, the ring being arranged on the lid 109. The ring is fixed on the lid 109 by means of the heat-shrink tubing 111 applied to the lateral housing surface 101c.

FIG. 6 shows a cell 100. It comprises a cylindrical metal housing 101 comprising a circumferential lateral housing surface 101c and, at the lower end face, a circular bottom 101b. The housing 101 is formed from the housing cup 108 and the lid 109. The lid 109 has a circular edge onto which an electrically insulating gasket 110 has been pulled on. Arranged in the housing is the cylindrical composite body 102 consisting of spirally wound-up electrodes and separators. Exiting from the upper end face of the composite body 102 is a conductor 105 that electrically connects a positive electrode of the composite body 102 to the lid 109. Exiting from the lower end face of the composite body 102 is a conductor 106 that electrically connects a negative electrode of the composite body 102 to the housing cup 108. The lateral housing surface 101c is electrically insulated by the heat-shrink tubing 111. An RFID transponder 103 is arranged between the heat-shrink tubing 111 and the lateral housing surface 101c.

What is claimed is:

1. An electrochemical cell capable of energy storage, comprising:
a housing that encloses an interior space,
a composite body arranged in the interior space and formed from at least two electrodes and at least one separator, and
an RFID transponder, the memory of which contains data about the cell.

2. The cell according to claim 1, wherein at least one of:
a. the data allow unambiguous identification of the cell,
b. the data allow assignment of the cell to a machine which was used in production of the cell, and
c. the data comprise information about components of the cell about the composite body and/or the at least two electrodes.

3. The cell according to claim 1, wherein at least one of:
a. the composite body is a cylindrical winding in which the at least two electrodes and the at least one separator are tape-shaped and spirally rolled-up,
b. the composite body comprises an axial cavity,
c. the RFID transponder is arranged in the axial cavity, and
d. the RFID transponder is a winding core or part of a winding core.

4. The cell according to claim 1, wherein:
a. the composite body is a cylindrical winding in which the at least two electrodes and the at least one separator are tape-shaped and spirally rolled-up, b. the RFID transponder is integrated in an adhesive strip or arranged on an adhesive strip, which adhesive strip is adhered to the winding on the lateral surface, and
c. the winding is held together by the adhesive strip.

5. The cell according to claim 1, wherein at least one of:
a. the housing is a cylindrical metal housing comprising a circumferential lateral housing surface and, at the end faces, a circular bottom and a lid,
b. the bottom and/or the lateral housing surface are covered by an electrically insulating layer on their outer face, and
c. the RFID transponder is arranged between the bottom and the electrically insulating layer or between the lateral housing surface and the electrically insulating layer or is integrated in the electrically insulating layer.

6. The cell according to claim 1, wherein at least one of:
a. the housing is a cylindrical metal housing comprising a circumferential lateral housing surface and, at the end faces, a circular bottom and a lid,
b. the RFID transponder is integrated in an electrically insulating ring or is a ring arranged on the lid, and
c. the ring is fixed on the lid by heat-shrink tubing applied to the lateral housing surface.

7. A method of producing an electrochemical cell capable of energy storage, comprising:
forming a housing that encloses an interior space,
arranging a composite body in the interior space and formed from at least two electrodes and at least one separator,
equipping the cell with an RFID transponder, the memory of which contains information about the cell.

8. The method according to claim 7, wherein at least one of:
a. the composite body is a cylindrical winding in which the at least two electrodes and the at least one separator are tape-shaped and spirally rolled-up,
b. the composite body comprises an axial cavity, and
c. the RFID transponder is arranged in the axial cavity.

9. The method according to claim 7, wherein at least one of:
a. the RFID transponder is a winding core or part of a winding core, and
b. the at least two electrodes and the at least one separator are tape-shaped and are spirally rolled up on the winding core to form the composite body, resulting in a cylindrical winding.

10. The method according to claim 7, wherein at least one of:
a. the at least two electrodes and the at least one separator are tape-shaped and are spirally rolled up to form the composite body, resulting in a cylindrical winding,
b. the winding is held together by an adhesive strip adhered to the winding on the lateral surface, and
c. the RFID transponder is integrated in the adhesive strip or arranged on the adhesive strip.

11. The method according to claim 7, wherein at least one of:
a. the housing is a cylindrical metal housing comprising a circumferential lateral housing surface and, at the end faces, a circular bottom and a lid,
b. the bottom and/or the lateral housing surface are covered by an electrically insulating layer on their outer face, and
c. the RFID transponder is arranged between the bottom and the electrically insulating layer or between the lateral housing surface and the electrically insulating layer or it is integrated in the electrically insulating layer.

12. The method according to claim 7, wherein at least one of:
a. the housing is a cylindrical metal housing comprising a circumferential lateral housing surface and, at the end faces, a circular bottom and a lid,
b. the RFID transponder is integrated in an electrically insulating ring or is a ring, the ring being arranged on the lid, and
c. the ring is fixed on the lid by heat-shrink tubing applied to the lateral housing surface.
